(19) United States
(12) Patent Application Publication
(10) Pub. No.: US 2014/0242698 A1
(43) Pub. Date: Aug. 28, 2014

(54) MEDICAL RECORDS STORAGE SYSTEM

(71) Applicant: Complete Consent, LLC, Savannah, GA (US)

(72) Inventor: Sidney P. Smith, Savannah, GA (US)

(73) Assignee: Complete Consent, LLC, Savannah, GA (US)

(21) Appl. No.: 14/189,022

(22) Filed: Feb. 25, 2014

Related U.S. Application Data
(60) Provisional application No. 61/768,619, filed on Feb. 25, 2013.

(51) Int. Cl. G06F 19/00

(52) U.S. Cl. CPC G06F 19/323
USPC 435/440; 705/3

(57) ABSTRACT

Electronic medical records have to evolve from the isolated hospital systems or insurance company owned storage data silos based on a binary code accessed by patients through portals to the patient themselves becoming the data silo with portals to which all hospital systems or insurance companies send data for storage and future access. Transfer processes for binary or non-binary data systems facilitate data into patient centered servers, which combine source of origination codes. Combining the patient specific genome sequence with binary data generates a 3D data set which has more information than each data set alone. The patient's binary code represents the externally expressed DNA sequence. From this combination, future medical events can be predicted. Also, the system enables bidirectional data transfer so that health systems no longer need to maintain expensive data silos which are incomplete.

### CROSS-REFERENCES TO RELATED APPLICATIONS

This application claims the benefit of U.S. Provisional Patent Application Ser. No. 61/768,619, filed Feb. 25, 2013, the entire content of which is herein incorporated by reference.

### STATEMENT REGARDING FEDERALLY SPONSORED RESEARCH OR DEVELOPMENT

(Not Applicable)

### BACKGROUND AND SUMMARY OF THE INVENTION

Conceptually the electronic medical record has to evolve from isolated hospital systems or insurance company owned storage data silos based on a binary code accessed by patients through portals to the patients themselves becoming the data silo with portals to which all hospital systems or insurance companies send data for storage and future access. This is the natural evolution of medical data storage from what currently exists in our world. The patient must be where all data with source codes is stored and combined with their own DNA sequencing to achieve the full medical and financial benefit for the patient. As the only constant in an infinite number of possible medical data generating events, the patient centered data silos yield benefits beyond simple recalling data. The embodiments of this new system are placed a dedicated server (so-called “My Records for Life” or MRFL).

The current state of the electronic medical record is a fragmented landscape with non-communicating data silos that only under pressure from the Federal Government have recently allowed patients partial access to PDF files. Though helpful, a PDF file is a limited tool only allowing visual information transfer without the ability to integrate data, allow data mining, or the ability to have verifiable source codes. Also, PDF files do not have intrinsic value to the patient for insurance underwriting as there is no system to tag the data with source codes to validate origination. To advance beyond the PDF file limitations, EHR systems must send complete binary data, and patients must have systems enabled to receive such data. Currently, software systems enabling sending or receiving patient binary data do not exist. Additionally, even if binary data with source codes could be sent and stored, there is no described system to combine the binary data with the patient's genetic DNA. Through combining the binary linear data which is the external expression of a patient's DNA with their DNA sequence we are able to generate patient unique data storage. The patient's unique newly generated data storage on MRFL is called the Alpha Omega Source Data (AO). The AO data has many benefits for each patient.

Universally all healthcare providers agree that the patient is the reason for collecting health care data, but few agree on what data to share. Hospital systems, EHR companies, and doctors are reluctant to send their binary data as this would be an added expense to integrate with patient centered data silos, limit their control over patients, result in the loss of a revenue stream through selling medical records, are concerned about the added oversight that data transfer would enable, and they do not want to be relegated to data entry sites with patient centric empowered data. However, the value to the patient outweighs the concerns of the medical industry.

Patients who have their entire AO medical record data are empowered with several advantages. The AO record data enables a patient to transfer care seamlessly between hospital systems, enables a patient to seek a second opinion without requesting records, enables a patient to take advantage of advanced analysis of their records and DNA for self-analysis and analysis with their entire family data, enables patients to transfer their data to future generations to benefit their children, have peace of mind knowing their complete data set is with them and not a third party, enable them to financially benefit from the data in their silo when companies want to use their data for studies or for insurance underwriting, and know they are in sole control of their own information generated during life.

The system of the preferred embodiments combines traditional binary code data which is in reality the external manifestation of a person's DNA recorded in each cell in a patient's body with source tags that describe the data origin. Though there is an infinite possibility of combinations, a patient's DNA sequence is relatively stable and when compared to the binary data, repeatable and unique patterns are seen. We call the unique information generated a patient's 3D code because we take a linear binary system and combine it with a chemically based three dimensional system, the patient's DNA. The relationship between the binary data recorded in a patient's medical record including the history, examinations, labs, tests, x-rays, diagnosis, treatments, outcomes etc. and the patterns that develop when matched to a patient's DNA sequences enable novel 3D data sets for storage. When created, the 3D patient data information is greater than the sum of two data sets, is unique in its ability to predict future medical events, serves as data storage, and offers greater clinical understanding of a patient and his or her future generations.

Once combined for a specific patient, the 3D data can generate a unique DNA sequence that maybe inserted into a living cell thus maintaining a person's data in a living environment. This living 3D data stored in a DNA sequence of a living cell can be reproduced and modified over time.

The system of the preferred embodiments endeavors to develop a novel data storage system evolving from the currently fragmented electronic binary system and paper medical record system into a patient centered data storage system integrated with the patient's DNA. The binary data is transferred to the MRFL servers. The system may be used with smart phone or computer apps that enable data to be transferred from non-binary systems such as paper records and binary records such as electronic health systems. The system may also “tag or label” non-binary or binary data with source of origin. Once data is combined with the source of origin codes, the patient's DNA sequences are combined to form their unique 3D data (the Alpha Omega Data System (AO)). The MRFL server enables bidirectional transfer of binary data to other servers recording medical data for patients such as hospital systems or any other healthcare providers. The AO data on MRFL serves as the new and only needed storage silo server for all health care systems, medical facilities, insurance companies, and healthcare providers. Also, AO data can be sent to insurance companies or can be released for medical studies, and the patient can be paid for the value of their records.

The AO data with its 3D data can then be used to generate new DNA sequences that hold the patient's data which are then inserted into living cells. This moves data storage from a binary system into a living system that can regenerate and grow over time.

Once the patient's data is being continually stored in their personal data MRFL silo, the patient is empowered to learn from university studies using their data, able to financially benefit from their data transfer to insurance companies and able to help their future generations by comparing their 3D data to their heath and passing the meaning on to their heirs.

The patient is also enabled to be the data source and depository for all his or her future interaction with hospital systems, physicians, or health care teams.

In order to transfer data into MRFL and achieve these goals with the current rudimentary state of medical records, several processes are described. There are two basic medical records currently in existence. One is the paper record or a non-binary record, and the other is the binary record used with computers. The system of the described embodiments enables transfer of both non-binary and binary system data into MRFL enabling data to be inserted into the appropriate patient data silo.

With non-binary paper records, used in many medical settings, apps are described enabling patients to generate scan codes on their smart phones or computers. These scan codes may be e-faxed to the provider caring for a patient or the scan code is generated by the patient on their phone. The phone face is then photocopied by the health care person sending information to MRFL. The scan code has instructions as to patient demographics, date of service, and nature of service and server location codes. When paper non-binary records are faxed, the scan code is placed first in the fax directing MRFL servers where to place the files. The scan code is also used if the records are sent through e-faxes. The scan codes direct the MRFL servers where to insert data into the data silo. After arrival at MRFL server, software adds source codes to all data.

With binary records used by hospital systems, physician offices, and other health care professionals, encoded directions are generated with the smart phone apps or computers which are sent to the hospital, physician, or other health care professional instructing the providers and their electronic health record servers to transfer the basic binary data to the MRFL patient specific portal. Also a bidirectional HL-7 or similar link is established to make the MRFL servers the primary data storage site for all patient data. The bidirectional HL-7 or similar link may be used as the bridge for all binary systems to transfer all medical data for each patient on MRFL. Once the patient's binary data is transferred to the MRFL server, source of origin codes are attached to all data.

The binary data which represents the data collection of the medical community is then combined with the patient's DNA sequence to generate the unique data—the 3D data stored in the Alpha Omega System. Through the combination of both the binary data and the chemical 3D DNA sequences, a more complete understanding of the patient and the complete record can be achieved. Within the MRFL server and the bidirectional portals, the patients are empowered to send their records to insurance companies, participate in medical studies, share their medical history with future generations, and predict future medical events. Also, a novel data storage system is described that uses living cells infused with the DNA sequences generated from combining the binary code and the patient's DNA. This moves data storage from an electronic binary system to a living system that can evolve over time.

In an exemplary embodiment, a method for storing medical procedure information into a patient electronic medical record includes the steps of (a) processing the medical procedure information according to a format of the medical procedure information, where the format of the medical procedure information varies by service provider; (b) parsing the processed information into information details including patient identification information, date of medical procedure, the service provider, and service performed; and (c) storing the parsed information in the patient electronic medical record.

Step (a) may be practiced by generating a machine-readable code representative of the medical procedure information, and wherein step (b) is practiced by reading the code. The machine-readable code may be a bar code. The method may also include printing the machine-readable code and receiving the machine-readable code by facsimile.

When the medical procedure information is in a text-based format, step (a) may be practiced by identifying a content pattern of the medical procedure information and categorizing the medical procedure information based on the identified content pattern. The medical procedure information may be sent by e-mail from the service provider.

Step (a) may be practiced by providing a link to the patient electronic medical record and enabling the service provider to send the medical procedure information directly to the patient electronic medical record. The link may provide access to a form for completion by the service provider, and step (b) may be practiced by enabling the service provider to directly input the information details of the medical procedure information.

The information details may include a summary of the medical procedure generated by the service provider, an operative report summarizing a surgical procedure, or laboratory evaluations.

In another exemplary embodiment, a computer program is stored on a non-transitory computer-readable medium for storing medical procedure information into a patient electronic medical record. The computer program is executed by a computer processor to carry out the steps of the noted method.

In yet another exemplary embodiment, a computer system stores medical procedure information into a patient electronic medical record. The system includes at least one user computer running a computer program that sends the medical procedure information in any format, which varies by service provider. A system server runs a server program, and the at least one user computer and the system server are interconnected by a computer network. The system server processes the medical procedure information according to the format of the medical procedure information and parses the processed information into information details including patient identification information, date of medical procedure, the service provider, and service performed. The system server stores the parsed information in the patient electronic medical record.

### BRIEF DESCRIPTION OF THE DRAWINGS

These and other aspects and advantages will be described in detail with reference to the accompanying drawings, in which:

FIG. 1 shows a process for paper records;

FIG. 2 shows a process for electronic records sent with no instructions;

FIG. 3 shows a process for electronic records sent with instructions;

FIG. 4 is a schematic of the MRFL server with the AO System; and

FIG. 5 is a detailed schematic of a computer system.

### DETAILED DESCRIPTION OF THE INVENTION

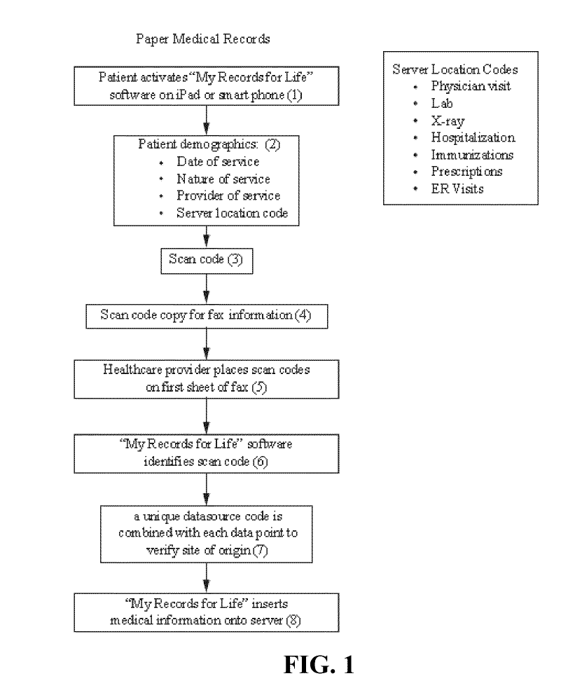

With reference to the drawings, the process works in four different settings. In FIG. 1, the first process is creating scan codes or bar codes that are created by patients on their smart phones or laptop (1). The scan code created (3) is copied on a photocopy (4) machine or e-faxed to a physician or health system. These scan codes are faxed as the first page of a fax (5) from the health provider's office. The scan codes have all the personal identifying data (2) and specify the date, provider giving the service, and notice of the service. When received by the MRFL server as the first page of a fax (5) from the healthcare professional to the server (electronic receiving platform) (MRFL), the system automatically identifies the scan code (6) and tags all data transferred with a source code to verify the data source of origin (7). Subsequently, the server places the information on the correct area on the server for the patient (8). That is, the data from the processed bar code is parsed into the information with source tagging. An example would be a patient's laboratory evaluations information scanned to the correct area or a person having a physical examination having this information sent to the physician examination area on the server.

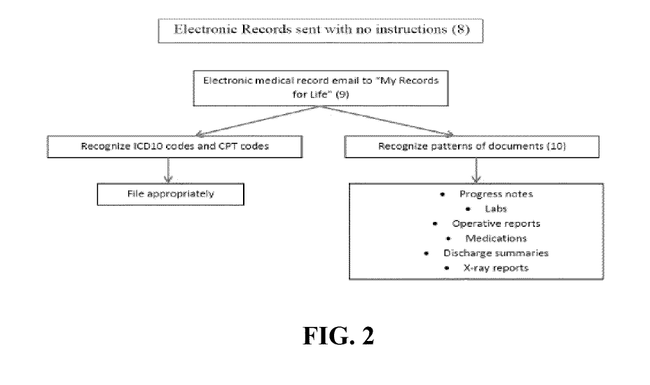

In FIG. 2, the second process relates to emailed information sent from a healthcare professional or hospital server that has binary data transferred to the MRFL server with no patient generated encoded directions. The binary data must be inserted into the correct site on the server. Because medical records have a conserved format, the MRFL server matches patterns of transferred documents to define the attributes of each document. Though not all records will able to be described and may have to have additional human review, most can be correctly placed.

The MRFL server scans for data sets in the binary code on documents that are repeatable. Most medical documents have the patient's name, date of birth, date of service, physician performing the service, location of testing, and ordering physician, subject matter of the document, standard terms such as history of present illness or reason for visit, present illness, physical examination, vital signs, performance status, clinical impression or assessment, social history, past medical history, review of systems, allergies, current medication list, allergies, and problem list, lab results, assessment, plan, and treating physician. Also, all lab results are displayed in a similar manner. Additionally, the MRFL server can identify universal binary codes for the International Classification of Diseases (ICD-10) and the Current Procedural Termination codes (CPT)

Information sent with no encoded instruction is scanned by the MRFL server, and through evaluation of the binary code identifies documents and is able to place them in the correct server space for patients (8).

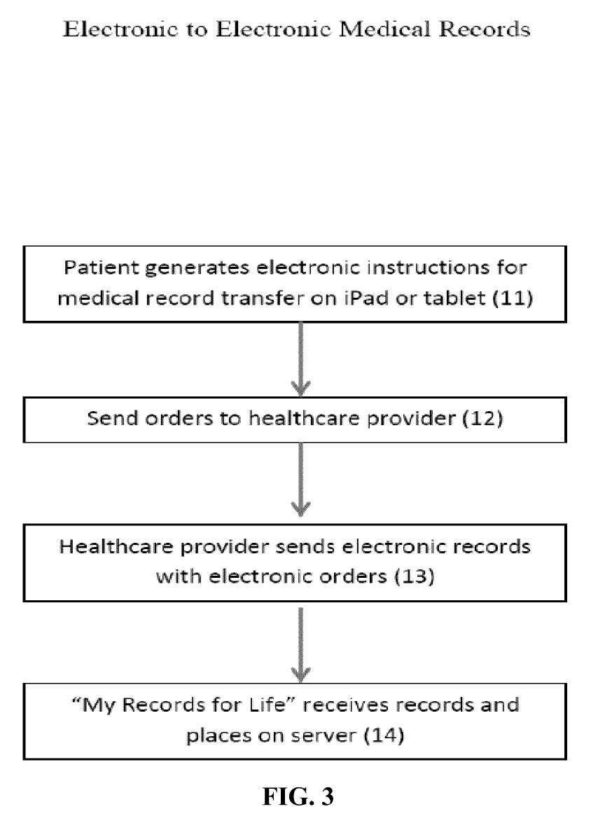

In FIG. 3, the third process is to send an electronic order or encoded instructions to the patient's healthcare provider or health system from their tablet or iPhone with specific instructions as to where to automatically send the information generated at the healthcare provider's office or hospital (11). That is, the specific instructions to send the basic binary code to the MRFL server which will also identify data types/categories for storage in the patient medical record. The Affordable Care Act states that patients are entitled to their medical records. An app associated with the present embodiments may enable patients to direct where and in what form their medical records will be sent. Patients simply place a standing set of encoded orders with their current primary care physician or hospital where they receive care instructing the physician or hospital to automatically forward all records to the MRFL server site in a binary form (12).

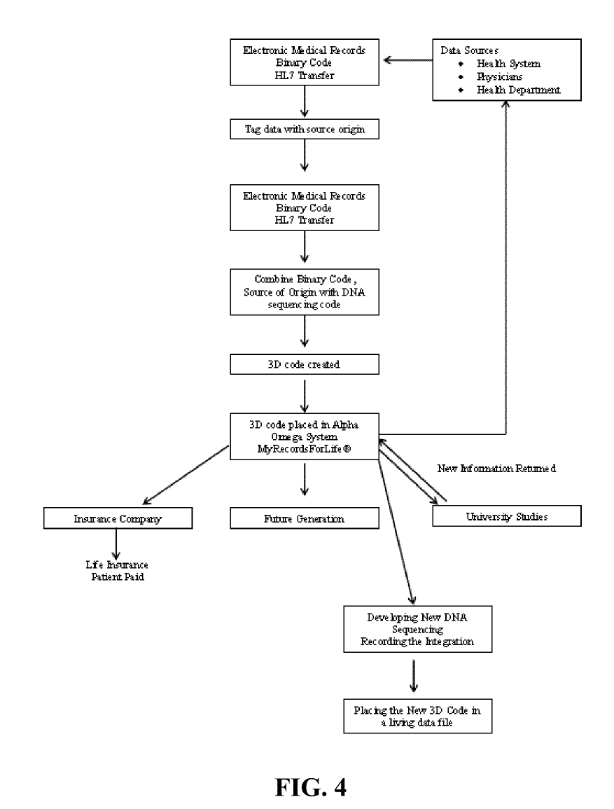

In FIG. 4, with medical data sent through fax or E-fax, or encoded instruction, the MRFL servers tags the data with the source of origin for all data so that where data originates is known. This becomes important when a patient electronically sends their records to an insurance company for medical underwriting because insurance companies only accepts verified source medical information. A typical patient would save about $1000 in premiums through this transfer with MRFL.

After the Binary code is combined with the source of origination, the MRFL server combines the patient's DNA sequencing code. The process of combining a binary code with a DNA sequence code involves software that maps specific medical findings such as diabetes, rheumatoid arthritis, or psoriasis with known DNA patterns that have a tendency to express certain features. Basically, the binary code is the recorded expression of the underlying cellular DNA, and by combining the two you have the complete medical record that portrays what has happened and can predict what may happen medically to a patient. Eventually, all medical care will be at the genomic level with drugs response based on the patient's DNA expressed patterns. The combined code of the patient's DNA and binary code is called the Alpha Omega system on the MRFL server. The AO data can be used for university studies, predicating responses to drug therapy, making predictions about future medical events, and predicating how family members with the same AO findings my express their DNA and develop certain medical issues.

The MRFL server then takes the AO data and through DNA sequencing machines currently in the market, generates new DNA sequences that are then inserted into living cells to have living data storage that can be manipulated over time. This step takes data from the binary code universal in all computers and develops a living DNA sequences code.

The medical records storage process described with reference to FIGS. 1-4 is preferably a browser-based system in which a program running on a user's computer (the user's web browser) requests information from a server program running on a system server. The system server sends the requested data back to the browser program, and the browser program then interprets and displays the data on the user's computer screen. The process is as follows:

1. The user runs a web browser program on his/her computer.

2. The user connects to the server computer (e.g., via the Internet). Connection to the server computer may be conditioned upon the correct entry of a password as is well known.

3. The user requests a page from the server computer. The user's browser sends a message to the server computer that includes the following:
the transfer protocol (e.g., http://); and
the address, or Uniform Resource Locator (URL).

4. The server computer receives the user's request and retrieves the requested page, which is composed, for example, in HTML (Hypertext Markup Language).

5. The server then transmits the requested page to the user's computer.

6. The user's browser program receives the HTML text and displays its interpretation of the requested page.

Thus, the browser program on the user's computer sends requests and receives the data needed to display the HTML page on the user's computer screen. This includes the HTML file itself plus any graphic, sound and/or video files mentioned in it. Once the data is retrieved, the browser formats the data and displays the data on the user's computer screen. Helper applications, plug-ins, and enhancements such as Java™ enable the browser, among other things, to play sound and/or display video inserted in the HTML file. The fonts installed on the user's computer and the display preferences in the browser used by the user determine how the text is formatted.

If the user has requested an action that requires running a program (e.g., a search), the server loads and runs the program. This process usually creates a custom HTML page “on the fly” that contains the results of the program's action (e.g., the search results), and then sends those results back to the browser.

Browser programs suitable for use in connection with the account management system of the present invention include Mozilla Firefox® and Internet Explorer available from Microsoft® Corp.

While the above description contemplates that each user has a computer running a web browser, it will be appreciated that more than one user could use a particular computer terminal or that a “kiosk” at a central location (e.g., a cafeteria, a break area, etc.) with access to the system server could be provided.

It will be recognized by those in the art that various tools are readily available to create web pages for accessing data stored on a server and that such tools may be used to develop and implement the system described below and illustrated in the accompanying drawings.

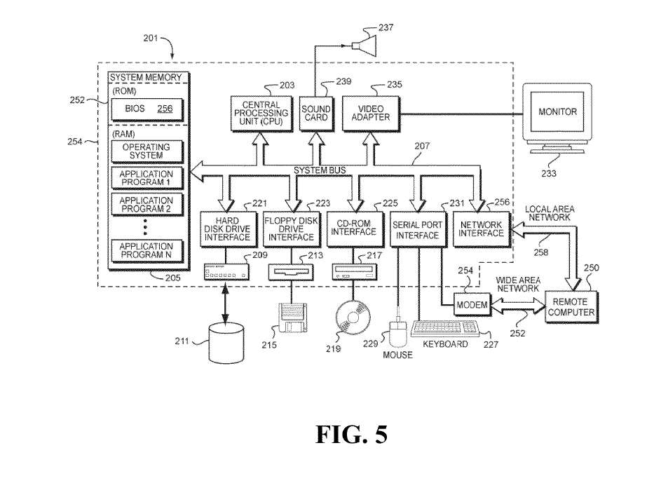

FIG. 5 generally illustrates a computer system 201 suitable for use as the client and server components of the described system. It will be appreciated that the client and server computers will run appropriate software and that the client and server computers may be somewhat differently configured with respect to the processing power of their respective processors and with respect to the amount of memory used. Computer system 201 includes a processing unit 203 and a system memory 205. A system bus 207 couples various system components including system memory 205 to processing unit 203. System bus 207 may be any of several types of bus structures including a memory bus or memory controller, a peripheral bus, and a local bus using any of a variety of bus architectures. System memory 205 includes read only memory (ROM) 252 and random access memory (RAM) 254. A basic input/output system (BIOS) 256, containing the basic routines that help to transfer information between elements within computer system 201, such as during start-up, is stored in ROM 252. Computer system 201 further includes various drives and associated computer-readable media. A hard disk drive 209 reads from and writes to a (typically fixed) magnetic hard disk 211; a magnetic disk drive 213 reads from and writes to a removable “floppy” or other magnetic disk 215; and an optical disk drive 217 reads from and, in some configurations, writes to a removable optical disk 219 such as a CD ROM or other optical media. Hard disk drive 209, magnetic disk drive 213, and optical disk drive 217 are connected to system bus 207 by a hard disk drive interface 221, a magnetic disk drive interface 223, and an optical drive interface 225, respectively. The drives and their associated computer-readable media provide nonvolatile storage of computer-readable instructions, SQL-based procedures, data structures, program modules, and other data for computer system 201. In other configurations, other types of computer-readable media that can store data that is accessible by a computer (e.g., magnetic cassettes, flash memory cards, digital video disks, Bernoulli cartridges, random access memories (RAMs), read only memories (ROMs) and the like) may also be used.

A number of program modules may be stored on the hard disk 211, removable magnetic disk 215, optical disk 219 and/or ROM 252 and/or RAM 254 of the system memory 205. Such program modules may include an operating system providing graphics and sound APIs, one or more application programs, other program modules, and program data. A user may enter commands and information into computer system 201 through input devices such as a keyboard 227 and a pointing device 229. Other input devices may include a microphone, joystick, game controller, satellite dish, scanner, or the like. These and other input devices are often connected to the processing unit 203 through a serial port interface 231 that is coupled to the system bus 207, but may be connected by other interfaces, such as a parallel port interface or a universal serial bus (USB). A monitor 233 or other type of display device is also connected to system bus 207 via an interface, such as a video adapter 235.

The computer system 201 may also include a modem or broadband or wireless adapter 237 or other means for establishing communications over the wide area network 239, such as the Internet. The modem 237, which may be internal or external, is connected to the system bus 207 via the serial port interface 231. A network interface 241 may also be provided for allowing the computer system 201 to communicate with a remote computing device 250 via a local area network 258 (or such communication may be via the wide area network 239 or other communications path such as dial-up or other communications means). The computer system 201 will typically include other peripheral output devices, such as printers and other standard peripheral devices.

As will be understood by those familiar with web-based forms and screens, users may make menu selections by pointing-and-clicking using a mouse, trackball or other pointing device, or by using the TAB and ENTER keys on a keyboard. For example, menu selections may be highlighted by positioning the cursor on the selections using a mouse or by using the TAB key. The mouse may be left-clicked to select the selection or the ENTER key may be pressed. Other selection mechanisms including voice-recognition systems, touch-sensitive screens, etc. may be used, and the invention is not limited in this respect.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method for storing medical procedure information into a patient electronic medical record, the method comprising:
(a) processing the medical procedure information according to a format of the medical procedure information, wherein the format of the medical procedure information varies by service provider;
(b) parsing the processed information into information details including patient identification information, date of medical procedure, the service provider, and service performed; and
(c) storing the parsed information in the patient electronic medical record.

2. A method according to claim 1, wherein step (a) is practiced by generating a machine-readable code representative of the medical procedure information, and wherein step (b) is practiced by reading the code.

3. A method according to claim 2, wherein the machine-readable code comprises a bar code.

4. A method according to claim 2, further comprising printing the machine-readable code and receiving the machine-readable code by facsimile.

5. A method according to claim 1, wherein the medical procedure information is in a text-based format, and wherein step (a) is practiced by identifying a content pattern of the medical procedure information and categorizing the medical procedure information based on the identified content pattern.

6. A method according to claim 5, wherein the medical procedure information is sent by e-mail from the service provider.

7. A method according to claim 1, wherein step (a) is practiced by providing a link to the patient electronic medical record and enabling the service provider to send the medical procedure information directly to the patient electronic medical record.

8. A method according to claim 7, wherein the link provides access to a form for completion by the service provider, and wherein step (b) is practiced by enabling the service provider to directly input the information details of the medical procedure information.

9. A method according to claim 1, wherein the information details include a summary of the medical procedure generated by the service provider, an operative report summarizing a surgical procedure, or laboratory evaluations.

10. A computer program stored on a non-transitory computer-readable medium for storing medical procedure information into a patient electronic medical record, the computer program being executed by a computer processor to carry out the steps of:
(a) processing the medical procedure information according to a format of the medical procedure information, wherein the format of the medical procedure information varies by service provider;
(b) parsing the processed information into information details including patient identification information, date of medical procedure, the service provider, and service performed; and
(c) storing the parsed information in the patient electronic medical record.

11. A computer program according to claim 10, wherein step (a) is practiced by generating a machine-readable code representative of the medical procedure information, and wherein step (b) is practiced by reading the code.

12. A computer program according to claim 11, wherein the machine-readable code comprises a bar code.

13. A computer program according to claim 11, further comprising printing the machine-readable code and receiving the machine-readable code by facsimile.

14. A computer program according to claim 10, wherein the medical procedure information is in a text-based format, and wherein step (a) is practiced by identifying a content pattern of the medical procedure information and categorizing the medical procedure information based on the identified content pattern.

15. A computer program according to claim 14, wherein the medical procedure information is sent by e-mail from the service provider.

16. A computer program according to claim 10, wherein step (a) is practiced by providing a link to the patient electronic medical record and enabling the service provider to send the medical procedure information directly to the patient electronic medical record.

17. A computer program according to claim 16, wherein the link provides access to a form for completion by the service provider, and wherein step (b) is practiced by enabling the service provider to directly input the information details of the medical procedure information.

18. A computer program according to claim 10, wherein the information details include a summary of the medical procedure generated by the service provider, an operative report summarizing a surgical procedure, or laboratory evaluations.

19. A computer system for storing medical procedure information into a patient electronic medical record, the system comprising:
at least one user computer running a computer program that sends the medical procedure information in any format, which varies by service provider; and
a system server running a server program, the at least one user computer and the system server being interconnected by a computer network, the system server processing the medical procedure information according to the format of the medical procedure information and parsing the processed information into information details including patient identification information, date of medical procedure, the service provider, and service performed, the system server storing the parsed information in the patient electronic medical record, wherein the system server combines source of data origination with a unique source tag.

20. A method for developing a 3D code combining patient specific binary data, source of origin codes, and a patient specific genome, the method comprising:
(a) developing a bidirectional HL-7 transfer mechanism for binary code;
(b) bidirectional transferring data from a system servers and from health systems, physicians, health department, insurance companies, and universities;
(c) tagging the binary code with source of origin code;
(d) combining the binary code and the source of origin code with a patient's DNA genome sequence;
(e) developing the 3D code that represents the combination of the patient's DNA genome sequence and the binary data;
(f) sending 3D code to a third party for study;
(g) developing new DNA sequences from the 3D code in an Alpha Omega system; and
(h) inserting new DNA sequences into living cells to be a living data file.
